(19) United States
(12) Patent Application Publication
(10) Pub. No.: US 2009/0141847 A1
(43) Pub. Date: Jun. 4, 2009

(54) METHOD FOR OPERATING NUCLEAR POWER GENERATION PLANT AND NUCLEAR POWER GENERATION PLANT

(75) Inventors: Tetsushi HINO, Hitachi (JP); Masao CHAKI, Hitachi (JP); Motoo AOYAMA, Mito (JP); Takeshi MITSUYASU, Hitachi (JP); Yoshihiko ISHII, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-GE Nuclear Energy, Ltd.

(21) Appl. No.: 12/324,936

(22) Filed: Nov. 28, 2008

(30) Foreign Application Priority Data
Nov. 30, 2007 (JP) 2007-310113

(51) Int. Cl. G21D 3/10; G21C 7/08; G21C 7/32; G21C 7/00

(52) U.S. Cl. 376/207; 376/237; 376/328; 376/210

(57) ABSTRACT

An method for operating a nuclear power generation plant, comprising the steps of:
forming a plurality of control rod patterns by operating a plurality of control rods during a first period of one operation cycle of a reactor including said first period before a point of time when all control rods are completely withdrawn from a core of said reactor and a core flow rate reaches firstly a set core flow rate, and a second period after said point of time,
controlling stepwise at least once a temperature of feed water supplied to said reactor based on a different set feed water temperature during a period included in said first period for operating said reactor with a formed same control rod pattern, and
continuing feed water temperature control based on said set feed water temperature until said core flow rate reaches a set core flow rate set based on said set feed water temperature.

### CLAIM OF PRIORITY

The present application claims priority from Japanese Patent application serial no. 2007-310113, filed on Nov. 30, 2007, the content of which is hereby incorporated by reference into this application.

### BACKGROUND OF THE INVENTION

The present invention relates to a method for operating a nuclear power generation plant and a nuclear power generation plant, and more particularly, to a method for operating a nuclear power generation plant and a nuclear power generation plant which are applied to a boiling water nuclear power generation plant, increase the power generation capacity, and are suitable for a long-term operation.

In the nuclear power generation plant, when increasing the power generation capacity and moreover performing a long operation period, it is general to realize a correspondence of increasing the mean enrichment of ²³⁵U of a fuel assembly loaded in a core. Further, at end of a operation cycle, in order to supplement the insufficient reactivity, it is general to increase core flow rate, thereby lower the volume ratio (void fraction) of steam in the core, and promote moderation of neutrons. As one technique of changing the void fraction in the core for the reactivity adjustment, there is available feed water temperature control of changing the feed water temperature, thereby changing cooling water temperature of core inlet. The techniques of adjusting the reactivity under the feed water temperature control are disclosed in Japanese Patent Laid-Open No. Hei 8(1996)-233989 and Japanese Patent Laid-Open No. Sho 62(1987)-138794. Particularly, in Japanese Patent Laid-Open No. Hei 8(1996)-233989, it is described that in the great majority of the period of the operation cycle, the feed water temperature is kept at a highest feed water temperature and at the end time of the operation cycle, the feed water temperature is lowered to a lowest feed water temperature.

In Machine Design Manual, January, 1973, Machine Design Manual Edition Committee, pp. 1996-2010, Maruzen Co., Ltd., the upper limit coolant temperature at which no cavitation is caused by the recirculation pump in the reactor is described. In HLR-006, Rev. 1, “Boiling Water Nuclear Power Generating Station, Three-Dimensional Nuclear Hydro-Thermal Power Calculating Method”, September, 1984, pp. 2-11, Hitachi, Ltd., the three-dimensional nuclear hydro-thermal power calculating Method is explained.

### SUMMARY OF THE INVENTION

According to the prior arts aforementioned, if the power generation capacity is increased and the mean enrichment of the fuel assembly is increased for the long operation period, capacity factor of the nuclear power generation plant is increased due to the long operation period. However, a problem arises that, generally, the economical efficiency of fuel is lowered. Furthermore, when increasing the core flow rate, thereby supplementing the reactivity, at the current nuclear power generation plant, the feed water temperature is not controlled, and the feed water flow rate is decided in proportion to the power of the nuclear power generation plant, that is, the main steam flow rate, so that the following problem arises. Namely, in the reheat cycle for heating feed water by steam extracted from a turbine, by increasing the extraction rate of the steam from the turbine as much as possible, the heat efficient can be improved. However, a amount of the steam extracted from the turbine is set depending on the cooling water temperature at the core inlet when the core flow rate is maximized, so that when the core flow rate is lower than the maximum flow rate, there is room for increasing the amount of the extraction steam from the turbine, and there is room for improving the heat efficiency. Further, if thermal power of the core is not changed even with increase in the core flow rate, the feed water flow rate and feed water temperature are not changed particularly and in correspondence to the increase in the core flow rate, the rate of the feed water flow rate at a low temperature occupied in the core flow rate is reduced. Therefore, the cooling water temperature at the core inlet rises higher than that before the core flow rate is increased and the void fraction reduction efficiency of the core due to the increase in the core flow rate is lowered. As mentioned above, to improve the heat efficiency or economical efficiency of fuel, it may be considered that the feed water temperature must be changed in relation to the change in the core flow rate. In the prior arts of adjusting the reactivity by adjusting the feed water temperature, the logic of how to adjust concretely the feed water temperature is only related to the first stage, medium stage, and end stage of the operation cycle or so and there is no description related to the change in the core flow rate.

Further, even if either of the core flow rate and feed water temperature is changed, the reactivity of the core is changed, so that if the feed water temperature is changed in relation to the change in the core flow rate, to keep the thermal power of the reactor or power of a generator at a preset value, a problem arises that the control system is complicated as it is and the operability is impaired.

An object of the present invention is to provide an method for operating a nuclear power generation plant and a nuclear power generation plant capable of improving the operation rate of the plant and simplifying the feed water temperature control system.

Features of the present invention for attaining the above object are that one operation cycle of a reactor includes a first period before the point of time when all the control rods are completely withdrawn from a core of the reactor and core flow rate reaches a preset core flow rate and a second period after that point of time, and during the first period, a plurality of control rod patterns are formed by operating a plurality of control rods, and

during a period for operating the reactor with the formed same control rod pattern, and included in the first period, temperature of feed water supplied to the reactor is controlled stepwise at least once using a different set value of feed water temperature, and

feed water temperature control based on the set value of the feed water temperature is continued until the core flow rate reaches the preset core flow rate which is preset on the basis of the set value of feed water temperature.

Since during the period of operating the reactor with the formed same control rod pattern during the first period, the temperature of the feed water supplied to the reactor is controlled stepwise at least once using a different set value of feed water temperature, the coolant temperature at the core inlet can be higher than the conventional one. Therefore, the heat efficiency of the reactor can be improved. The feed water temperature is controlled stepwise on the basis of a plurality of set values of feed water temperature, so that the feed water temperature control can be simplified. Therefore, the feed water temperature control apparatus can be simplified.

The above object can also be accomplished, during each operation period using separately different control rod patterns formed in a reactor, by controlling stepwise at least once temperature of feed water supplied to the reactor using different set values of feed water temperature and

by executing continuously the feed water temperature control using the set value of the feed water temperature until core flow rate reaches set value of the core flow rate preset on the basis of the set value of the feed water temperature.

According to the present invention, the operation rate of the plant can be improved and the feed water temperature control system can be simplified.

### BRIEF DESCRIPTION OF THE DRAWINGS

FIG. 1 is a structural diagram showing the boiling water nuclear power generation plant of a first embodiment which is a preferable embodiment of the present invention,

FIG. 2 is an explanatory drawing showing an operating method executed in a boiling water nuclear power generation plant shown in FIG. 1,

FIG. 3 is a characteristic diagram comparing changes of reactivity of a core and minimum critical power ratio (MCPR) when core flow rate and core coolant temperature are changed,

FIG. 4 is an explanatory drawing showing an operating method executed in a boiling water nuclear power generation plant of a second embodiment which is another embodiment of the present invention,

FIG. 5 is an explanatory drawing showing an operating method executed in a boiling water nuclear power generation plant of a third embodiment which is still another embodiment of the present invention,

### DETAILED DESCRIPTION OF THE PREFERRED EMBODIMENTS

Embodiments of the present invention will be explained with reference to the drawings.

### First Embodiment

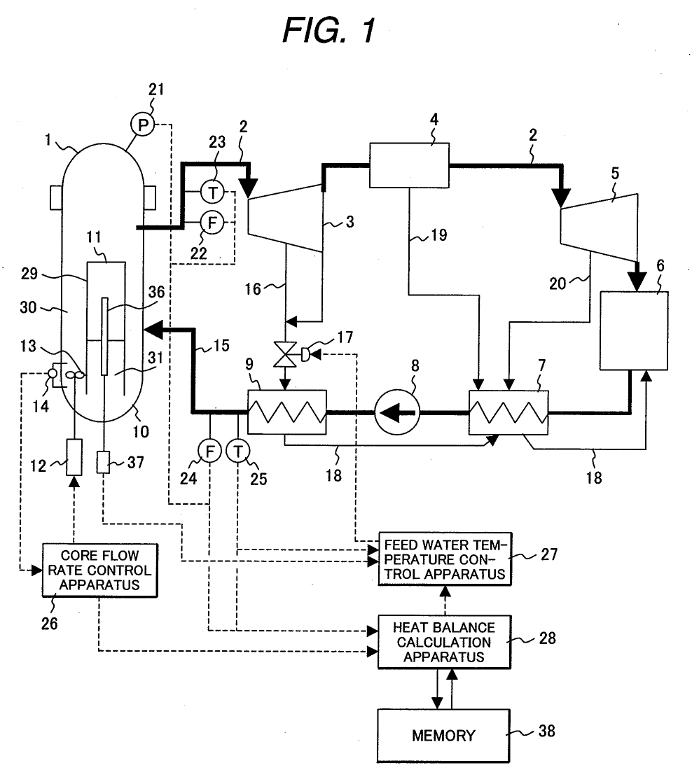

The nuclear power generation plant of a first embodiment which is a preferable embodiment of the present invention will be explained below by referring to FIGS. 1 to 3 using an example of a boiling water nuclear power generation plant.

The boiling water nuclear power generation plant is provided with a reactor 1, a high pressure turbine 3, a low pressure turbine 5, a condenser 6, a core flow rate control apparatus 26, a feed water temperature control apparatus 27, a heat balance calculation apparatus 28, and memory 38. The reactor 1 has a core 11 loading a plurality of fuel assemblies (not drawn) in a reactor pressure vessel (hereinafter, referred to RPV) 10. A cylindrical core shroud 29 surrounds the core 11 in the RPV 10. Internal pumps 12 are installed on the lower part of the RPV 10. An impeller 13 of the internal pump 12 is arranged in a down comer (a circular flow path) 30 formed between the RPV 10 and the core shroud 29. Inside the down comer 30, a differential pressure meter 14 for measuring the differential pressure between the upstream side and the downstream side of the impeller 13 is installed. A main steam pipe 2 connected to the RPV 10 connects the high pressure turbine 3, a moisture separator super heater (or a moisture separator re-heater) 4, and the low pressure turbine 5. The high pressure turbine 3 and low pressure turbine 5 are connected to a generator (not drawn). A feed water pipe 15 connects the condenser 6, a low pressure feed water heater 7, a feed water pump 8, and a high pressure feed water heater 9 in this order and is connected to the RPV 10. An extraction pipe 16 connected to the high pressure turbine 3 is connected to the high pressure feed water heater 9. A pipe 19 connected to the moisture separator super heater 4 and a pipe 20 connected to the low pressure turbine 5 are respectively connected to the low pressure feed water heater 7. A steam flow rate adjusting valve 17 is installed on the extraction pipe 16. A drain pipe 18 connected to the high pressure feed water heater 9 is connected to the condenser 6 via the low pressure feed water heater 7.

A pressure gauge 21 for detecting the inner pressure (steam pressure) of the RPV 10 is installed on the upper part of the RPV 10. A flow meter 22 for detecting the steam flow rate and a thermometer 23 for detecting the steam temperature are installed on the main steam pipe 2. A flow meter 24 for detecting the feed water flow rate and a thermometer 25 for detecting the feed water temperature are installed on the feed water pipe 15.

When the nuclear power generation plant is in operation, cooling water (a coolant) in the down comer 30 which is pressurized by the impeller 13 due to the rotation of the internal pump 12 is supplied to the core 11 through a lower plenum 31. This cooling water is supplied to the fuel assembly in the core 11 and is heated by heat generated by the nuclear fission of the nuclear fuel material and a part of the heated cooling water is vaporized. The moisture within the steam is removed by the steam separator (not drawn) and steam dryer (not drawn) installed above the core 11 in the RPV 10 and is discharged into the main steam pipe 2. The steam rotates the high pressure turbine 3, and the moisture within the steam is removed by the moisture separator super heater 4. Then the steam superheated by the moisture separator super heater 4 is supplied to the low pressure turbine 5 and rotates the low pressure turbine 5. Due to the rotation of the high pressure turbine 3 and low pressure turbine 5, the generator is rotated to generate electricity. The steam exhausted from the low pressure turbine 5 is condensed to water by the condenser 6.

This water is supplied to the RPV 10 as feed water through the feed water pipe 15. The feed water is heated by the low pressure feed water heater 7, is pressurized by the feed water pump 8, is heated to a further high temperature by the high pressure feed water heater 9, and then is supplied to the RPV 10. The low pressure feed water heater 7 heats the feed water by high-temperature drain water discharged from the moisture separator super heater 4 and steam and condensed water extracted from the low pressure turbine 5 which are introduced by the pipes 19 and 20. The high pressure feed water heater 9 heats the feed water discharged from the low pressure feed water heater 7 by steam which is extracted from the high pressure turbine 3 and introduced by the extraction pipe 16. The method for heating the feed water in this way using steam and condensed water which are extracted from the high pressure turbine 3 and low pressure turbine 5 is called a reheat cycle and can reduce the quantity of heat discarded for condensing. The reheat cycle improves the heat efficiency, so that it is generally applied to the BWR plant.

As the amount of the extraction steam from the low pressure turbine 5 and high pressure turbine 3 is increased and the temperature of the feed water supplied to the RPV 10 is raised, the heat efficiency of the BWR plant is improved. However, the feed water temperature is restricted from the viewpoint of keeping the soundness of the reactor recirculation system. Concretely, if the feed water temperature is raised excessively and the cooling water temperature rises excessively, bubbles (cavitation) are formed in cooling water round the impeller 13 of the internal pump 12, and there is a fear that the impeller 13 may be damaged by the cavitation. Thus, the feed water temperature is restricted so as to make the cooling water temperature lower than the upper limit temperature causing no cavitation. The upper limit temperature of cooling water causing no cavitation varies depending on the shape of the impeller 13, though in the current reactor, it is a temperature lower than the saturated temperature by about 10° C.

The cooling water temperature becomes the upper limit temperature causing no cavitation when the core flow rate becomes the maximum flow rate (hereinafter, referred to as the maximum core flow rate). When the core flow rate is lower than the maximum core flow rate (the set core flow rate), the cooling water temperature is lower than the upper limit temperature. Therefore, when the core flow rate is lower than the maximum core flow rate, there is room for increasing the amount of the extraction steam supplied to the feed water heater and there is room for improving the heat efficiency of the BWR plant. This embodiment, when the core flow rate is lower than the maximum core flow rate, is characterized in that the amount of the extraction steam supplied to the feed water heater is increased, and during the reactor operation, the mean feed water temperature in the operation cycle is made higher than the conventional one.

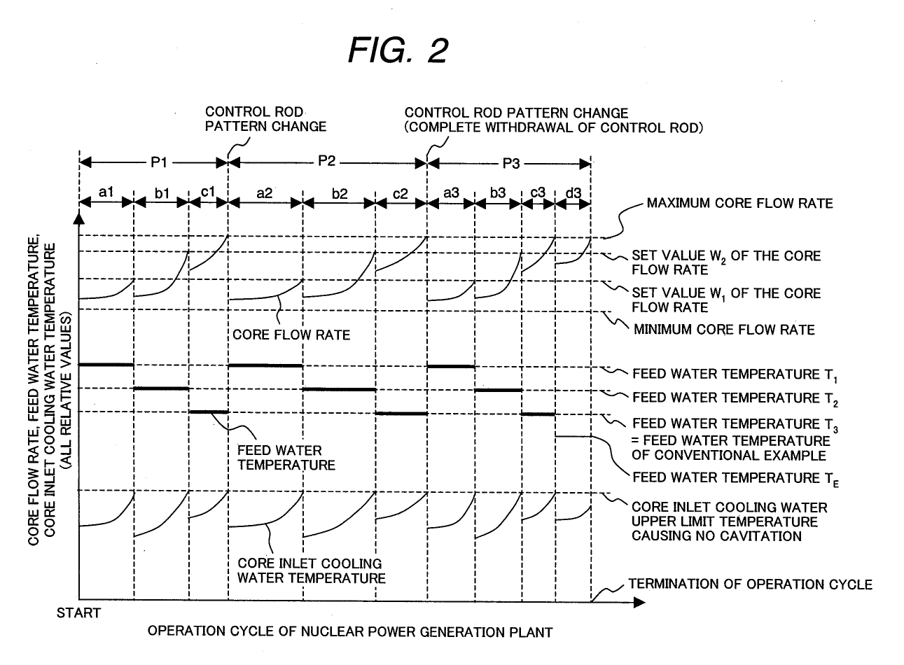

The outline of the operating method executed in the boiling water nuclear power generation plant shown in FIG. 1 will be explained by referring to FIG. 2. The operating method shown in FIG. 2 is conducted in the BWR plant having a core property that the reactivity to be suppressed in the core reduces uniformly from the start of the operation cycle to the end of the operation cycle. Such a core property is realized by adjusting the quantity of a burnable poison (for example, Gd) included in the fuel assembly loaded in the core 11 so that it suppresses the excess reactivity.

One operation cycle means a period from the operation start of the reactor 1 to the stop of the reactor 1 for exchanging the fuel assembly in the reactor 1. The operation cycle of this embodiment includes periods P1, P2, and P3 having different control rod patterns. During each of the periods P1, P2, and P3, the same control rod pattern is formed. The periods P1 and P2 are finished when the core flow rate reaches the maximum core flow rate (100% flow rate) and at that point of time, the control rod patterns are changed. The period P3 is a period during which the reactor is operated with the control rod pattern that all the control rods 36 are completely withdrawn from the core 11. During the periods P1 and P2, several control rods 36 are inserted into the core 11, though the control rod patterns are different from each other. During the period P1, the number of control rods 36 inserted into the core 11 is larger than that during the period P2.

In the current boiling water nuclear power generation plant, the feed water flow rate and feed water temperature are not adjusted as long as the reactor power is not changed. On the other hand, in the boiling water reactor, the core flow rate is changed properly through the operation cycle for adjusting the nuclear reactivity of the core based on the change in the void fraction of the core 11, so that the core flow rate is changed properly through the operation cycle. If the core flow rate is changed, in the RPV 10, the flow rate of the recirculation water almost at the saturated temperature which flows out from the core 11 and returns again to the core 11 via the down comer 30 and lower plenum 31 is changed. In the current boiling water nuclear power generation plant in which the feed water temperature and feed water flow rate are constant, the coolant temperature at the core inlet is lowered if the core flow rate is reduced and is raised when the core flow rate is increased. At this time, an amount of heat for heating the feed water is set under the condition that the core inlet coolant temperature is maximized, that is, even when the core flow rate is maximized, the core inlet coolant temperature is equal to or lower than the upper limit temperature causing no cavitation. Therefore, in the current boiling water nuclear power generation plant, when the core flow rate is lower than the maximum core flow rate, the core inlet coolant temperature is lower than the upper limit temperature causing no cavitation. This means that there is room for raising the feed water temperature, thus there is room for improving the heat efficiency.

On the other hand, in this embodiment, to solve this problem, during the period that the core flow rate is lower than the maximum core flow rate in one operation cycle, to permit the core inlet coolant temperature to approach the upper limit temperature as far as possible below the upper limit temperature causing no cavitation, a set value of the feed water temperature is set higher than that in the current boiling water nuclear power generation plant (conventional example) and a set value of the core flow rate is set based on the set value of the feed water temperature. In this embodiment, during the period that the core flow rate reaches the set value of the core flow rate, the feed water temperature is controlled based on the set value of the feed water temperature corresponding to the set value of the core flow rate.

In this embodiment with this technical thought reflected to, in the periods P1 and P2, three set values T₁, T₂ and T₃ of the feed water temperature are set so as to be reduced toward the point of end time of each period and in the period P3, four set values T₁, T₂, T₃ and T_{E} of the feed water temperature are set so as to be reduced toward the point of end time of this period. The set values T₁, T₂, T₃ and T_{E} of the feed water temperature are set stepwise so as to be T₁>T₂>T₃>T_{E} (refer to FIG. 2) based on the technical thought. Concretely, the set value T₁ of the feed water temperature is 225° C., and the set value T₂ of the feed water temperature is 220° C., and the set value T₃ of the feed water temperature is 215° C., and the set value T_{E} of the feed water temperature is 210° C. 215° C. is the set value of the feed water temperature of the conventional example. The periods P1 and P2, in relation to the set values of the feed water temperature, are divided into three periods a, b, and c and the period P3, in relation to the set value of the feed water temperature, is also divided into four periods a, b, c and d. Concretely, the period P1 has periods a1, b1 and c1 and the period P2 has periods a2, b2 and c2. The period P3 has periods a3, b3, c3 and d3. Each period of the periods a1, b1, c1, . . . , and d3 is referred to as a small section. The respective set values of the feed water temperature aforementioned are predetermined before starting up the boiling water nuclear power generation plant and are stored in the memory 38.

In this embodiment, the period from the point of time when the core flow rate reaches firstly the maximum core flow rate in the state that all the control rods 36 are completely withdrawn from the core 11 to the stop of the operation of the plant (the feed water temperature is set at 210° C.) is referred to as the end of the operation cycle. The end of the operation cycle is the period d3 and is referred to as the second period for convenience. The set value T_{E} of the feed water temperature of the second period is lowest in all the set values of the feed water temperature. In the operation cycle, the period previous to the second period is referred to as the first period.

During the first period, there are a plurality of periods having different control rod patterns. During these periods, the feed water control is executed toward the end time of each period on the basis of a plurality of different set values of the feed water temperature under the condition that the control rod pattern is not changed respectively.

In this embodiment, the reactor power is controlled by the operation of the control rod 36 (the withdrawal operation of the control rod 36 from the core 11 and the insertion operation of the control rod 36 into the core 11), the control for the core flow rate, and the control for the feed water temperature. The control rod 36 is connected to a control rod drive apparatus 37 and is operated by the control rod drive apparatus 37. The control for the core flow rate is executed by adjusting the cooling water flow rate discharged from the internal pump 12 by controlling the number of rotations of the internal pump 12.

The core flow rate control apparatus 26 inputs the measured value of the differential pressure, measured by the differential pressure meter 14, between the upstream side and the downstream side of the impeller 13 in the down comer 30 and calculates the core flow rate based on the measured value. The core flow rate control apparatus 26 controls the number of rotations of the internal pump 12 based on the calculated core flow rate (hereinafter, for convenience, referred to as the measured value of the core flow rate) and the set value of the core flow rate in the operation cycle and controls the flow rate (core flow rate) of cooling water supplied to the core 11.

The operation of the BWR plant in one operation cycle will be explained. After the operation of the reactor was started up, since the control rod 36 is withdrawn from the core 11, the reactor 1 enters the critical state and the temperature and pressure of the reactor 1 is raised. After the pressure of the reactor 1 and the cooling water temperature in the reactor 1 reach respectively the set values, the reactor power is increased to the rated power (100% power). Namely, when the core flow rate is kept at the minimum core flow rate, the control rod 36 is withdrawn from the core 11 and the reactor power is increased. When the reactor power reaches, for example, 60%, the withdrawal operation of the control rod 36 is stopped, and the core flow rate is increased by the aforementioned control by the core flow rate control apparatus 26, and the reactor power is increased to the rated power. During the period al being subsequent period, the operation shown in FIG. 2 is executed. The reactor power is practically kept at the rated power during the period al and thereafter. When the aforementioned withdrawal operation of the control rod 36 is stopped, the first control rod pattern is formed. The period P1 is operated by this first control rod pattern.

The heat balance calculation apparatus 28 inputs the reactor pressure measured by the pressure gauge 21, the steam flow rate measured by the flow meter 22, the steam temperature measured by the thermometer 23, the feed water flow rate measured by the flow meter 24, the feed water temperature measured by the thermometer 25, the measured value of the core flow rate outputted from the core flow rate control apparatus 26, and the set value of the feed water temperature stored in the memory 38 and stores these information in the memory 38. The heat balance calculation apparatus 28, among these input information, based on the information on the reactor pressure P, feed water flow rate W_{feed}, and set value T of the feed water temperature, as described later, calculates the set value of the core flow rate using Formula (1). Further, among the information which is inputted in the heat balance calculation apparatus 28 and is stored in the memory 38, the feed water temperature and the measured value of the core flow rate are used for control for the feed water temperature by the feed water control apparatus 27 and the steam temperature is used for calculation of the reactor power and for confirmation of the saturated temperature at the reactor pressure P.

The aforementioned set value of the core flow rate is obtained for each of the periods a1, b1, a2, b2, a3 and b3. The set values of the core flow rate, from the viewpoint of raising the feed water temperature as high as possible on the average in the operation cycle, are decided so that the cooling water temperature becomes a temperature which is equal to or lower than the upper limit temperature causing no cavitation by the internal pump 12 and is close to the upper limit temperature. The heat balance calculation apparatus 28 calculates those set values of the core flow rate using Formula (1). The set values of the core flow rate are calculated for each set value of the feed water temperature and for example, they are calculated by the heat balance calculation apparatus 28 after start of the period at the time of setting each feed water temperature.

W×h_{core}={(W−W_{feed})×hₛₐₜ(P)+W_{feed}×h(T, P)} (1)

where W indicates a core flow rate (a set value of the core flow rate), h_{core} indicates a core inlet enthalpy, W_{feed} indicates a feed water flow rate, hₛₐₜ indicates an enthalpy of the saturated water (depending on the pressure), T indicates a feed water temperature, and P indicates a reactor pressure. Further, h_{core} is calculated based on Tᵢₙ=f (P_{L}, h_{core}) Where P_{L} indicates pressure of the lower plenum in the RPV 10 and Tᵢₙ indicates a cooling water temperature at the core inlet. The lower plenum pressure P_{L} is a reactor pressure which is corrected by adding the static water head pressure of the cooling water in the down comer 30 in the reactor 1 and the increased pressure of the internal pump 12 to the reactor pressure P. Further, the lower plenum pressure P_{L} may be directly measured by a pressure gauge newly installed.

The heat balance calculation apparatus 28 calculates respectively set values W₁ of the core flow rate at which the coolant temperature is close to the upper limit temperature causing no cavitation for set value T₁ of the feed water temperature of each period “a” of the periods P1, P2, and P3, and set value W₂ of the core flow rate at which the coolant temperature is close to the upper limit temperature causing no cavitation for set value T₂ of the feed water temperature of each period “b” of the periods P1, P2, and P3, based on each measured value at the concerned period of time. The set values of the core flow rate during the periods c1, c2, c3, and d3 are the maximum core flow rate, so that they are not calculated by the heat balance calculation apparatus 28. There is the following relationship between set values W₁ and W₂ of the core flow rate set as mentioned above:

Minimum core flow rate<W₁<W₂<maximum core flow rate

At the time of a certain feed water temperature T, set value W of the core flow rate at which the coolant temperature is close to the upper limit temperature T_{in max} causing no cavitation can be obtained based on the h_{core} corresponding to the T_{in max} and Formula (1). Here, the coolant temperature which is the upper limit temperature T_{in max} causing no cavitation depends on the shape of the impeller 13 of the internal pump 12, though it can be set by experimentation and simulation (refer to Machine Design Manual, January, 1973, Machine Design Manual Edition Committee, pp. 1996-2010, Maruzen Co., Ltd.).

The operation of the plant during each of the periods a1, b1 and c1 of the period P1 will be explained below. During the period a1 where the reactor power reaches the rated power, until the core flow rate (hereinafter, for convenience, referred to as the measured value of the core flow rate) obtained by the core flow rate control apparatus 26 increases and reaches set value W₁ of the core flow rate, the feed water control based on set value T₁ of the feed water is executed. The feed water temperature control apparatus 27 inputs the feed water temperature measured by the thermometer 25 and the measured value of the core flow rate and set value T₁ of feed water temperature from the memory 38 and executes the feed water temperature control based on them. The feed water temperature control apparatus 27 controls a degree of opening of the steam flow rate adjusting valve 17 so as to set the measured feed water temperature to set value T₁ (225° C.) of the feed water temperature and adjusts the flow rate of extracted steam supplied to the high-pressure feed water heater 9. During the period a1, the feed water at set value T₁ of the feed water temperature is introduced into the RPV 10 via the feed water pipe 15. As the operation period elapses, the fissile material included in the nuclear fuel material in the fuel assembly is consumed and the reactor power is apt to reduce below the rated power. To compensate for the reduction in the reactor power, the number of rotations of the internal pump 12 is increased under the control of the core flow rate control apparatus 26 and the core flow rate is increased. During the period a1, since the feed water temperature is kept at set value T₁ of the feed water temperature, as the core flow rate for compensating for the reduction in the reactor power increases, the core inlet cooling water temperature rises. When the measured value of the core flow rate reaches set value W₁ of the core flow rate, the core inlet cooling water temperature rises close to the upper limit temperature causing no cavitation and the operation during the period al is finished. Further, set value W₁ of the core flow rate is calculated by the heat balance calculation apparatus 28 after start of the period a1.

When the measured value of the core flow rate reaches set value W₁ of the core flow rate, the feed water temperature control apparatus 27 controls the degree of the opening of the steam flow rate adjusting valve 17 based on set value T₂ (220° C.) of the feed water temperature inputted from the memory 38, and adjusts the temperature of feed water supplied to the RPV 10 to set value T₂ of the feed water temperature. In this way, the operation during the period b1 is started and the feed water temperature during the period b1 is kept at the set value T₂ of the feed water temperature. The temperature of water supplied to the RPV 10 is lowered from 225° C. to 220° C. At the point of time when the feed water temperature is switched to the set value of the feed water temperature to be lowered, that is, at the point of time when the period b1 is started, the reactor power is apt to exceed the rated power. The increase in the reactor power, if the feed water temperature is lowered based on the set value of the feed water temperature reduced, is realized when the void fraction of the core 11 is reduced temporarily and the reactivity of the core 11 is increased. To avoid the increase in the reactor power, at the point of time when set value T₁ of the feed water temperature is switched to set value T₂ of the feed water temperature, the core flow rate control apparatus 26 reduces the number of rotations of the internal pump 12 and reduces the core flow rate. Concretely, during the period from the termination of the period a1 to the start of the period b1, as shown in FIG. 2, the core flow rate is reduced in correspondence with the reduction in the set value of the feed water. The core inlet cooling water temperature is also lowered. The reduction in the core flow rate increases the void fraction of the core 11 and suppresses the reactivity of the core 11. Due to the reduction in the core flow rate, during the period from the period al to the period b1, the reactor power is kept at the rated power.

If the increase range of the reactor power due to the reduction in the feed water temperature is smaller than the reduction range of the reactor power due to the core flow rate control, the reactor power can be practically kept at the rated power. According to the examination of the inventors, it is found that when in the current boiling water nuclear power generation plant, when the heat capacity of the feed water pipe and the change speed of the reactor power due to the core flow rate control are considered, if the change range of the feed water temperature is about 10° C. or lower, the reactor power can be kept practically constant. However, even when the change range of the feed water temperature is higher than 10° C., by increasing the heat capacity of the feed water pipe or reducing the change speed of the feed water heating rate, the reactor power can be kept constant without increasing the change range of the reactor power due to the core flow rate control.

To compensate for the reduction in the reactor power due to consumption of the fissile material, even during the period b1, the core flow rate is increased as in the case of the period a1. When the core flow rate is increased to set value W₂ of the core flow rate, the core inlet cooling water temperature rises close to the upper limit temperature causing no cavitation and the operation of the period b1 is finished. During the period b1 and moreover the subsequent period c1, the core inlet cooling water temperature rises in correspondence to the increase in the core flow rate for compensating for the reduction in the reactor power.

When the measured value of the core flow rate reaches set value W₂ of the core flow rate, set value T₂ of the feed water temperature is changed to set value T₃ of the feed water temperature and the operation of the period c1 is started. The feed water temperature control apparatus 27 controls the degree of the opening of the steam flow rate adjusting valve 17 based on set value T₃ (215° C.) of the feed water temperature inputted from the memory 38 and adjusts the feed water temperature to set value T₃ of the feed water temperature. When it is changed to set value T₃ of the feed water temperature, that is, when the period c1 is started, the core flow rate and core inlet cooling water temperature are lowered in the same way as the period b1 is started. Therefore, the reactor power is kept at the rated power from the period b1 to the period c1. Even during the period c1, to compensate for the reduction in the reactor power due to consumption of the fissile material, the core flow rate is increased. When the core flow rate is increased to the maximum core flow rate which is the set value of the core flow rate corresponding to set value T₃ of the feed water temperature, the core inlet cooling water temperature rises close to the upper limit temperature causing no cavitation and the operation of the period c1 is finished.

At this time, after the core flow rate is reduced by the core flow rate control apparatus 26 so as to control the thermal power of the core to 60 to 70% or so, the first control rod pattern change is executed. The control rod pattern change is executed by controlling the concerned control rod drive apparatus 37 by the control rod drive control apparatus (not drawn) and operating the concerned control rod 36. When the first control rod pattern change is finished, the second control rod pattern is formed. During the period P2, that is, the periods a2, b2 and c2, the reactor is operated by the second control rod pattern. After this control rod pattern change is finished, the reactor power is increased up to the rated power due to an increase in the core flow rate.

The respective set values of the core flow rate during the periods a2, b2 and c2 of the period P2 are set values W₁ and W₂ of the core flow rate and the maximum core flow rate during the periods a1, b1 and c1, so that there is no need to calculate the set value of the core flow rate by the heat balance calculation apparatus 28.

Changing set value T₃ of the feed water temperature to set value T₁ of the feed water temperature from the termination time of the reactor operation during the period c1 to the start time of the operation during the period a2 is executed as indicated below by the feed water control apparatus 27. Namely, the feed water control apparatus 27 changes set value T₃ of the feed water temperature to set value T₁ of the feed water temperature when it is decided that the second control rod pattern is formed based on the positions, inputted into the feed water control apparatus 27, of the respective control rods 36 detected by the respective control rod drives 37 in the height direction of the core 11. The feed water control apparatus 27 executes the feed water temperature control before the measured value of the core flow rate reaches set value W₁ of the core flow rate, that is, during the period a2 using set value T₁ of the feed water temperature in the same way as during the period a1. At the start time of the period a2, as shown in FIG. 2, the core flow rate and core inlet cooling water temperature are lowered and thereafter, during the period a2, as the core flow rate increases up to set value W₁ of the core flow rate, the core inlet cooling water temperature also rises. When the core flow rate increases up to set value W₁ of the core flow rate, the core inlet cooling water temperature rises close to the upper limit temperature causing no cavitation and the operation of the reactor 1 during the period a2 is finished.

The feed water control apparatus 27 executes the feed water temperature control before the measured value of the core flow rate reaches set value W₂ of the core flow rate, that is, during the period b2 using set value T₂ of the feed water temperature in the same way as during the period b1. When the period b2 is started, the core flow rate and core inlet cooling water temperature are lowered. Thereafter, as the core flow rate increases up to set value W₂ of the core flow rate, the core inlet cooling water temperature also rises. When the core flow rate increases up to set value W₂ of the core flow rate, the core inlet cooling water temperature rises close to the upper limit temperature causing no cavitation and the operation of the reactor 1 during the period b2 is finished.

Also during the period c2 the feed water control apparatus 27 executes the feed water temperature control using set value T₃ of the feed water temperature as in the case of the period c1. The feed water temperature control is executed until the measured value of the core flow rate reaches the maximum core flow rate which is the set value of the core flow rate. When the measured value of the core flow rate reaches the maximum core flow rate, the core inlet cooling water temperature rises close to the upper limit temperature causing no cavitation and the operation of the reactor 1 during the period c2 is finished.

Further, when the period b2 is started and when the period c2 is started, at each period of time, so as to compensate for the increase in the reactivity of the core 11 due to the lowering of the feed water temperature, the core flow rate is reduced by the core flow rate control apparatus 26. Therefore, the reactor power can be kept at the rated power from the period a2 to the period c2.

Thereafter, the second control rod pattern change is executed in the same way as with the first control rod pattern change. In this embodiment, the second control rod pattern change is a final control rod pattern change. The third control rod pattern that all the control rods 36 are completely withdrawn from the core 11 is formed in the core 11. After the second control rod pattern change is executed, the core flow rate is increased and the reactor power is increased up to the rated power. During the period P3, the reactor is operated by the third control rod pattern. The change from set value T₃ of the feed water temperature after the termination of the period c2 to set value T₁ of the feed water temperature during the period a3, is executed by the feed water temperature control apparatus 27 in the same way as with the change from set value T₃ of the feed water temperature during the period c1 to set value T₁ of the feed water temperature during the period a2.

During the periods a3, b3 and c3 of the period P3 during which the reactor is operated with the third control rod pattern, the feed water temperature control executed during the corresponding periods a1, b1 and c1 is executed. Namely, during the period a3, the feed water temperature control apparatus 27 executes the feed water temperature control based on the set value T₁ of the feed water temperature. During the period b3, the feed water temperature control apparatus 27 executes the feed water temperature control using the set value T₂ of the feed water temperature. The feed water temperature control apparatus 27, during the period c3, executes the feed water temperature control using set value T₃ of the feed water temperature. During these periods a3, b3, and c3, the core flow rate control using the core flow rate control apparatus 26 similar to that of the corresponding periods a1, b1, and c1 is executed. During period a3, the core flow rate control is executed until the measured value of the core flow rate reaches the set value W₁ of the core flow rate. During period b3, the core flow rate control is executed until the measured value of the core flow rate reaches the set value W₂ of the core flow rate. During period c3, the core flow rate control is executed until the measured value of the core flow rate reaches the maximum core flow rate which is the set value of the core flow rate. Furthermore, when the period b3 is started and when the period c3 is started, at each period of time, so as to compensate for the increase in the reactivity of the core 11 due to the lowering of the feed water temperature, the core flow rate is reduced by the core flow rate control apparatus 26. Therefore, the reactor power can be kept at the rated power from the period a3 to the period c3.

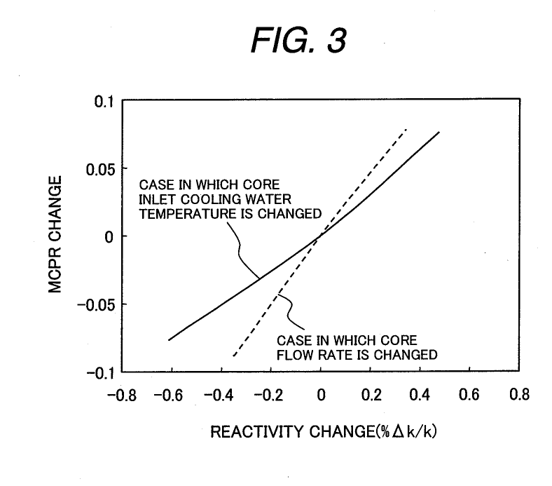

On the other hand, the minimum critical power ratio (MCPR) which is one index of the thermal margin for the core reactivity, is changed as shown by the solid line in FIG. 3 when the core inlet cooling water temperature is changed and is changed as shown by the dotted line in FIG. 3 when the core flow rate is changed. The smaller the MCPR is made, the smaller the thermal margin will be made. The characteristics shown in FIG. 3 show that the change of the thermal margin when the core flow rate is changed is larger than that when the core inlet cooling water temperature is changed to change the same core reactivity. Therefore, as described above, for example, when the period is changed from the period a1 to the period b1, that is, at the point of time when the set value of the feed water temperature is changed, if the reactor power is kept at the rated power by lowering the feed water temperature and core flow rate as mentioned above, there is a possibility that the thermal margin may be reduced from that during the period before lowering the feed water temperature. Therefore, desirably, when the feed water temperature is lowered by changing the set value of the feed water temperature, the MCPR after changing the set value of the feed water temperature is calculated by a core performance calculation apparatus (not shown), and only when the calculated MCPR is larger than the operation restricted value, the set value of the feed water temperature is reduced by the feed water temperature control apparatus 27 (for example, from T₁ to T₂), thereby the feed water temperature is controlled to be lowered. If when the calculated MCPR is smaller than the operation restricted value, for example, during the period b1 after movement, as a set value of the feed water temperature, using set value T₁ of the feed water temperature during the preceding period al instead of set value T₂ of the feed water temperature after changing, the feed water temperature is controlled.

When the measured value of the core flow rate reaches the maximum core flow rate during the period c3, the feed water temperature control apparatus 27 changes set value T₃ of the feed water temperature to set value T_{E} (210° C.) of the feed water temperature and the operation of the boiling water nuclear power generation plant during the period d3 is continued. The change of the set value of the feed water temperature is executed when the feed water temperature control apparatus 27 decides that the measured value of the core flow rate inputted from the core flow rate control apparatus 26 reaches the maximum core flow rate and all the control rods are completely withdrawn from the core 11 based on the control rod information inputted from the control rod drive apparatus 37. When set value T₃ of the feed water temperature is changed to set value T_{E} of the feed water temperature, the core flow rate is reduced to keep the reactor power at the rated power, similarly to the case that set value T₁ of the feed water temperature is changed to set value T₂ of the feed water temperature. In addition to it, the core inlet cooling water temperature is also lowered. During the period d3, the feed water temperature control apparatus 27 controls the degree of the opening of the steam flow rate adjusting valve 17 based on set value T_{E} of the feed water temperature and adjusts the feed water temperature to set value T_{E} of the feed water temperature. During the period d3, the temperature of water supplied to the RPV 10 is kept at set value T_{E} of the feed water temperature. When the core flow rate reaches the maximum core flow rate during the period d3, the operation of the reactor during the period P3, that is, in the operation cycle is finished. At this time, the reactor is stopped.

In this embodiment, the change of the set value of the feed water temperature during the periods P1, P2 and P3, that is, the change to set values T₁, T₂, T₃ and T_{E} of the feed water temperature is executed when the measured value of the core flow rate is increased up to the set value of the core flow rate. In this embodiment, during each of the period a1 to the period d3, the core inlet cooling water temperature rises in proportion to the increase in the core flow rate.

In this embodiment that the reactivity to be suppressed in the core 11 is reduced uniformly, as shown in FIG. 2, during each period between the period al and the period d3, the core flow rate is increased uniformly. Further, when the reactivity of the core 11 to be suppressed is reduced uniformly, generally, the inserted amount of the control rods 36 in the core 11 using the first control rod pattern during the period P1 is larger than that of control rods 36 using the second control rod pattern during the period P2.

In this embodiment, during the period (the second period) after the point of time when the core flow rate reaches firstly the maximum core flow rate in the state that all the control rods 36 are completely withdrawn from the core 11, that is, the period d3, the feed water temperature is made lower than the feed water temperature immediately before the core flow rate reaches firstly the maximum core flow rate in the state that all the control rods 36 are completely withdrawn from the core 11, so that the reactivity can be increased due to the reduction in the core inlet cooling water temperature. Therefore, in this embodiment, the period of one operation cycle can be made longer than that of the conventional example and the operation rate of the nuclear power generation plant can be improved.

In this embodiment, in one operation cycle, during the period (the first period) before the point of time when the core flow rate reaches the maximum core flow rate in the state that all the control rods 36 are completely withdrawn from the core 11, that is, from the period al to the period c3, set values T₁ and T₂ of the feed water temperature during the periods a1, b1, a2, b2, a3 and b3 other than the period during which the set value of the core flow rate is the maximum core flow rate, are made higher than the set value of the feed water temperature of the conventional example by applying the technical thought aforementioned. Therefore, in correspondence to it, the core inlet cooling water temperature during the periods a1, b1, a2, b2, a3 and b3 can be made higher than that of the conventional example. Namely, since during the periods a1, b1, a2, b2, a3 and b3, the set value of the core flow rate is set so that the cooling water temperature becomes a temperature which is equal to or lower than the upper limit temperature causing no cavitation by the internal pump 12 and is close to the upper limit temperature, the core inlet cooling water temperature becomes a temperature which is equal to or lower than the upper limit temperature causing no cavitation and is closer to the upper limit temperature. Accordingly, in this embodiment, the heat efficiency can be increased from that of the conventional example. The economical efficiency of fuel in this embodiment is improved than that of the conventional example. Naturally, during the periods a1, b1, a2, b2, a3 and b3, no cavitation is caused by the internal pump 12.

In this embodiment, during the period that the reactor is operated with the same control rod pattern, the feed water temperature is controlled stepwise based on a plurality of set values of the feed water temperature at different temperatures, so that the feed water temperature control can be simplified. Therefore, in this embodiment, the feed water temperature control apparatus 27 and heat balance calculation apparatus 28 can be simplified.

When the feed water temperature control apparatus 27 adjusts the steam flow rate adjusting valve 17 so that the feed water temperature becomes set values T₁, T₂ and T₃ of the feed water temperature stored in the memory 38, due to the heat capacity of the feed water pipe 15, the feed water temperature is reduced continuously for some time at the point of time when the set value of the feed water temperature is changed from T₁ to T₂ or from T₂ to T₃. To “control stepwise” aforementioned includes the case that the feed water temperature is reduced continuously in that way at the point of time when the set value of the feed water temperature is changed.

To prevent an occurrence of cavitation by the pump, the core inlet cooling water temperature must be set to the upper limit temperature causing no cavitation by the pump for feeding cooling water to the core or lower. The core inlet cooling water temperature is determined by the flow rate of cooling water (core flow rate) at the saturated temperature supplied to the core 11, feed water temperature, and feed water flow rate. The smaller the flow rate of cooling water at a low temperature supplied to the core 11 is, the lower the core inlet cooling water temperature will be, so that in correspondence to it, the feed water temperature can be raised. Since the upper limit of the feed water temperature is restricted by the core flow rate, in order to raise the feed water temperature as high as possible, it is necessary to change the feed water temperature in accordance with the core flow rate. In other words, the respective set values of the core flow rate, which are not the maximum core flow rate, in the respective small sections (the periods a1, b1, a2, b2, a3 and b3) of the operation cycle may set based on the feed water set values in the concerned small sections. The feed water temperature control using the set values of the feed water temperature is continued until the core flow rate reaches the set value of the core flow rate (for example, set value W₁ of the core flow rate) set on the basis of the set value of the feed water temperature (for example, set value T₁ of the feed water temperature), so that the core inlet cooling water temperature can be prevented from exceeding the upper limit temperature causing no cavitation.

When the set value of the core flow rate is set without based on the set value of the feed water temperature, the following problem arises. Namely, when the excess reactivity is large and the core flow rate is low, although there is room for raising the feed water temperature higher, the feed water temperature is lowered. As a result, the heat efficiency cannot be improved more. Further, when the excess reactivity is small and the core flow rate is high, there is a possibility that the core inlet cooling water temperature may exceed the upper limit temperature causing no cavitation by the increase of the feed water temperature. This embodiment can avoid such a problem because the set value of the core flow rate is set based on the set value of the feed water temperature.

In this embodiment, the set value of the feed water temperature is changed twice during the period that the reactor is operated with the same control rod pattern in one operation cycle. However, during this period that the reactor is operated with the same control rod pattern, the set value of the feed water temperature can be changed only once or three times or more. This means that the feed water temperature is controlled stepwise at least once during the period that the reactor is operated with the same control rod pattern. When controlling stepwise the feed water temperature at least once, two or more set values of the feed water temperature used during the period that the reactor is operated with the same control rod pattern are set at different temperatures. The respective set values of the core flow rate corresponding to these feed water temperatures are set so that the core inlet cooling water temperature becomes a temperature which is equal to or lower than the upper limit temperature causing no cavitation and is closer to the upper limit temperature. During the periods included in the first period that the reactor is operated with the respective same control rod patterns, the set value of the feed water temperature used last is the same as the set value of the conventional example. Since the feed water temperature is controlled stepwise several times during the period that the reactor is operated with the same control rod pattern, in this embodiment, the heat efficiency is increased more compared with the case that the feed water temperature is controlled stepwise only once during the concerned period.

### Second Embodiment

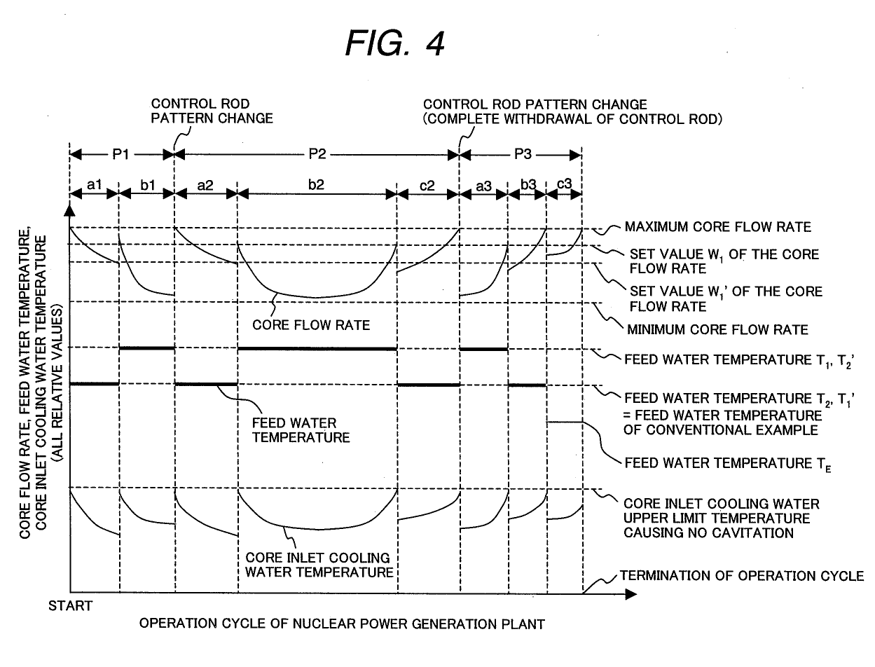

The nuclear power generation plant of a second embodiment which is another embodiment of the present invention will be explained below. The nuclear power generation plant of this embodiment is a boiling water nuclear power generation plant capable of executing the operating method shown in FIG. 4. The boiling water nuclear power generation plant of this embodiment has the hard construction of the boiling water nuclear power generation plant of Embodiment 1 as it is. The reactivity to be suppressed in the core 11, depending on the quantity of a burnable poison included in new fuel assemblies loaded firstly into the core 11, the quantity of a burcnable poison remaining in the fuel assemblies which are loaded in the core 11 during the operation in the preceding operation cycle and are not take out from the core 11 after the operation in this preceding operation cycle was finished, and the fuel loading pattern to be used in the next operation cycle in the core 11, may be maximized during the operation cycle. The core 11 of this embodiment has a construction that during the operation cycle, concretely in the middle of the operation cycle, the reactivity to be suppressed in the core 11 is maximized.

A method for operating the boiling water nuclear power generation plant having the above core 11 will be explained by referring to FIG. 4. Also in this embodiment, the operation of the period P1 is performed with the first control rod pattern and after changing the control rod pattern, the operation of the period P2 and the operation of the period P3 are performed respectively with the second control rod pattern and third control rod pattern. The period P1 includes the periods a1 and b1 and the period P2 includes the periods a2, b2 and c2. The period P3 includes the periods a3, b3 and c3.

The set values of the feed water temperature of the periods al and a2 are T₁′. The set values of the feed water temperature of the periods b1 and b2 are T₂′. The set value of the feed water temperature of the period a3 is T₁. The set values of the feed water temperature of the periods c2 and b3 are T₂. The set value of the feed water temperature of the period c3 is T_{E}. The set values of the core flow rate corresponding to the respective set values of the feed water temperature are obtained based on Formula (1) and are stored in the memory 38. These set values of the core flow rate are W₁′ during the periods a1 and a2, W₁ during the periods b2 and a3, and the maximum core flow rate during the periods c2, b3, and c3. The set value of the core flow rate during the period b1 is the minimum core flow rate for keeping the rated power. In this embodiment, the respective small sections between the periods a1 and a2 are periods for decreasing the core flow rate and keeping the rated power and the respective small sections between the periods c2 and c3 are periods for increasing the core flow rate and keeping the rated power. The period b2 is a period that the half thereof decreases the core flow rate and keeps the rated power and the other half thereof increases the core flow rate and keeps the rated power. In this embodiment, the set value T₁ of the feed water temperature and the set value T₂′ of the feed water temperature are equal such as 225° C. The set value T₂ of the feed water temperature and the set value T₁′ of the feed water temperature are equal such as 215° C. The set value T_{E} of the feed water temperature is 210° C. Further, T₁=T₂′ and T₂=T₁′ may not be held always and T₁>T₂ and T₁′<T₂′ may be acceptable.

Set values W₁ and W₁′ of the core flow rate corresponding respectively to the set values T₁ and T₁′ of the feed water temperature are set so that the core inlet cooling water temperature becomes a temperature which is equal to or lower than the upper limit temperature causing no cavitation and is closer to the upper limit temperature, similarly to the first embodiment.

The set values W₁ of the core flow rate when lowering the feed water temperature is set by calculating the core flow rate, at which the core inlet cooling water temperature becomes a temperature which is equal to or lower than the upper limit temperature causing no cavitation and is close to the upper limit temperature at the point of time when the core flow rate reaches the maximum core flow rate, by the heat balance calculation apparatus 28 similarly to the first embodiment.

On the other hand, when the feed water temperature is raised, the core flow rate is increased for keeping the reactor power at the rated power, so that the set value W₁′ of the core flow rate when raising the feed water temperature, in the status of the core flow rate increased, is set to the core flow rate at which the core inlet cooling water temperature becomes a temperature which is equal to or lower than the upper limit temperature causing no cavitation and is close to the upper limit temperature. For that purpose, the heat balance calculation apparatus 28 calculates the set value of the core flow rate as follows. As shown in FIG. 3, the feed water temperature change range and core flow rate change range which are necessary to change the same reactivity are obtained beforehand. The set value of the core flow rate can be calculated by adding the obtained the feed water temperature change range and core flow rate change range to the increased quantity of the core flow rate when the feed water temperature is raised. Further, it is possible to calculate the core flow rate for making the heat power of the reactor constant when the feed water temperature is raised, by the core performance calculation apparatus and input the calculated core flow rate to the heat balance calculation apparatus 28.

At the start time of the period a1, the core flow rate is increased up to the maximum core flow rate and the reactor power is kept at the rated power. During the period al, the feed water temperature control apparatus 27 controls the temperature of water supplied to the RPV 10 based on the set value T₁′ of the feed water temperature. Since the reactivity of the core 11 to be suppressed is increased during the period a1, in order to compensate for the increase in the reactor power, the core flow rate is reduced during the period al. When the measured value of the core flow rate is reduced to the set value W₁′ of the core flow rate, the operation of the boiling water nuclear power generation plant during the period a1 is finished. After the operation of the period a1, the set value of the feed water temperature is changed to T₂′, and the operation of the plant during period b1 is started. When the set value of the feed water temperature is increased from T₁′ to T₂′, the reactivity of the core 11 is reduced due to the rise of the feed water temperature, so that the core flow rate is increased. Therefore, the reactor power is kept at the rated power from the period a1 to the period b1.

During the period b1, the feed water temperature control based on the set value T₂′ of the feed water temperature is executed. Also during the period b1, the core flow rate is reduced and when the reactor power cannot be kept at the rated power due to the reduction in the core flow rate, the operation of the period b1 is finished. Thereafter, the first control rod pattern is executed and the second control rod pattern is formed. During the period a2, the feed water temperature control and core flow rate control similar to those of the period a1 are executed. During the period b2, the feed water temperature control is executed based on the set value T₂′ of the feed water temperature. The core flow rate during the period b2 is reduced until a half of the period b2 where the reactivity of the core 11 to be suppressed is maximized and is increased during the other half. By such core flow rate control, the reactor power during the period b2 is kept at the rated power.

During the periods c2, a3 and b3 of this embodiment, the feed water control and core flow rate control which are practically the same as those of the periods c2, b3, and c3 in the first embodiment are executed although the set value of the feed water temperature and the set value of the core flow rate are different. The feed water control and core flow rate control during the period c3 are also the same as those during the period d3 of Embodiment 1.

This embodiment can obtain the effects produced in the first embodiment.

### Third Embodiment

In the first and second embodiments, the examples of the operating method for predicting beforehand the change in the excess reactivity in the operation cycle and in accordance with the change in the excess reactivity, presetting the set value of the feed water temperature for each small section are described. Concretely, the first embodiment describes an example that the excess reactivity is reduced and during each period of the periods P1, P2 and P3, the set value of the feed water temperature in each small section is set so as to reduce toward the termination point of time of each period. Further, in the second embodiment, until the middle of the period P2 where the excess reactivity increases, the set value of the feed water temperature in each small section for each period is set so as to increase toward the termination point of time of each period and after the middle of the period P2 where the excess reactivity reduces, the set value of the feed water temperature in each small section for each period is set so as to reduce toward the termination point of time of each period.

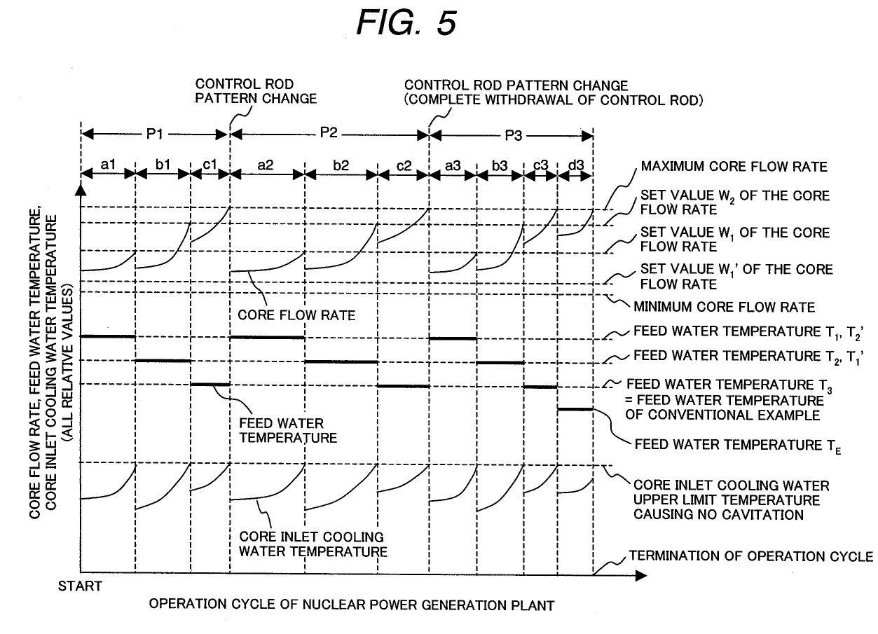

However, there is no need always to preset the set value of the feed water temperature for each small section. It is possible to hold the set values of the feed water temperature in the memory as a list and select any set value of the feed water temperature from the list during operation. The nuclear power generation plant of the third embodiment 3 which is another embodiment will be explained below by referring to FIG. 5.

The boiling water nuclear power generation plant of this embodiment has the hard construction of the boiling water nuclear power generation plant of the first embodiment as it is. Further, the excess reactivity is reduced similarly to the core of the first embodiment. The operation cycle in this embodiment has the periods P1, P2 and P3 having different control rod patterns similarly to the first embodiment. The same control rod patterns, that is, the first, second and third control rod patterns are formed during the periods P1, P2 and P3 respectively. The periods P1 and P2 are finished when the maximum core flow rate (100% flow rate) is obtained, though at that point of time, the control rod patterns are changed. The period P3 is a period during which the reactor is operated with the control rod pattern that all the control rods 36 are completely withdrawn from the core 11. During the periods P1 and P2, several control rods 36 are inserted into the core 11, though the control rod patterns are different from each other. During the period P1, the inserted amount of control rods 36 in the core 11 is larger than that during the period P2.

In this embodiment, the four kinds of set values of the feed water temperature of T₁=225° C., T₂=220° C., T₃=215° C., and T_{E}=210° C. which are the same as those of the first embodiment are stored beforehand in the memory 38 before starting the boiling water nuclear power generation plant. Here, the lowest set value T_{E}(=210° C.) of the feed water temperature is the set value of the feed water during the second period similarly to the first embodiment.

The respective set values of the feed water temperature in the first small sections a1, a2, and a3 of the respective periods are selected from the three kinds of set values T₁ to T₃ of the feed water temperature excluding T_{E} which are stored in the memory 38 and set as indicated below before start of the respective periods. Firstly, among the set values of the feed water temperature, the highest set value T₁ (225° C.) of the feed water temperature is selected and the core performance calculation apparatus calculates the core flow rate at which the core can keep critical at the rated power and the selected feed water temperature. The heat balance calculation apparatus 28 calculates the core inlet cooling water temperature based on the calculated core flow rate and the selected feed water temperature. If the calculated core inlet cooling water temperature is equal to or lower than the upper limit temperature causing no cavitation, the selected feed water temperature is set as a set value of the feed water temperature in this small section. If the calculated core inlet cooling water temperature is higher than the upper limit temperature causing no cavitation, among the set values of the feed water temperature, the second high set value T₂ (220° C.) of the feed water temperature is selected and the core performance calculation apparatus calculates the core flow rate which can keep critical at the rated power. The heat balance calculation apparatus 28 calculates the core inlet cooling water temperature from Formula (1) using this calculated core flow rate. This calculation is repeated until the core inlet cooling water temperature becomes equal to or lower than the upper limit temperature causing no cavitation. The feed water temperature when the core inlet cooling water temperature becomes equal to or lower than the upper limit temperature is set as a set value of the feed water temperature in the concerned small section. In this embodiment shown in FIG. 5, the respective set values of the feed water temperature in the small sections a1, a2 and a3 are set at the highest temperature T₁ by the aforementioned method.

The respective set values of the feed water temperature in the small sections b1, b2 and b3 following the first small sections a1, a2 and a3 of the respective periods are set as indicated below during operation in the small sections a1, a2 and a3.

Firstly, among the set values of the feed water temperature which are stored in the memory 38 and exclude the set values of the feed water temperature in the small sections a1, a2 and a3, the highest set value of the feed water temperature is selected. In this embodiment, since the respective set values of the feed water temperature in the small sections a1, a2 and a3 are set at the highest temperature T₁ (225° C.), the next high temperature T₂ (220° C.) is selected as the set values of the feed water temperature in the small sections b1, b2 and b3. The heat balance calculation apparatus 28, for the feed water temperature T₁ in the small sections a1, a2, and a3, obtains set value W₁ of the core flow rate at which the core inlet cooling water becomes close to the upper limit temperature causing no cavitation. The set value T₂ of the feed water temperature obtained as mentioned above is the set value of the feed water temperature to be set in the small sections b1, b2, and b3 when the core flow rates reach set value W₁ of the core flow rate in the respective small sections a1, a2 and a3, and is stored in the memory 38.

Furthermore, among the set values of the feed water temperatures which are stored in the memory 38 and are higher than the set values of the feed water temperature set in the small sections a1, a2 and a3, the lowest set value of the feed water temperature is selected. However, in this embodiment, since the feed water temperatures in the respective small sections a1, a2 and a3 are set at the highest temperature T₁ (225° C.), there are no set values of the feed water temperature corresponding to it. Therefore, the candidate of the feed water temperature to be set in the small sections b1, b2 and b3 is only T₂.

From the aforementioned, in the respective small sections a1, a2 and a3, when the core flow rate reaches actually the set value W₁ of the core flow rate, as shown in FIG. 5, the set value of the feed water temperature is reduced from T₁ to T₂ and the operation in the small sections b1, b2 and b3 is started. If in the small sections a1, a2 and a3, when the core flow rate does not reach the set value W₁ of the core flow rate, the operation in each of the small sections a1, a2 and a3 is continued with set value T₁ of the feed water temperature kept as it is.

Further, similarly to the first embodiment, the increase in the reactor power when the set value of the feed water temperature is reduced from T₁ to T₂ is compensated for by the reduction in the core flow rate and the reactor power is kept at the rated power.

The respective set values of the feed water temperature in the small sections c1, c2 and c3 respectively following the first small sections b1, b2 and b3 of the respective periods are also set as indicated below during operation in the small sections b1, b2 and b3 similarly to the small sections b1, b2 and b3.

Firstly, among the set values of the feed water temperature which are stored in the memory 38 and are lower than the set values of the feed water temperature set in the small sections b1, b2 and b3, the highest set value of the feed water temperature is selected. In this embodiment, the set values of the feed water temperature in the small sections b1, b2 and b3 are set at T₂, so that the next high temperature T₃ is selected. The heat balance calculation apparatus 28 obtains the set value W₂ of the core flow rate at which the core inlet cooling water becomes close to the upper limit temperature causing no cavitation for set value T₂ of the feed water temperature in the respective small sections b1, b2 and b3. The set value T₃ of the feed water temperature obtained as mentioned above is the set value of the feed water temperature to be set respectively in the small sections c1, c2 and c3 and is stored in the memory 38 when the core flow rates reach set value W₂ of the core flow rate in the respective small sections b1, b2 and b3.

Furthermore, among the set values of the feed water temperature which are stored in the memory 38 and are higher than set value T₂(=T₁′) of the feed water temperature set in the respective small sections b1, b2 and b3, the lowest set value of the feed water temperature is selected. Concretely, it is T₁(=T₂′). Next, set value W₁′ of the core flow rate when increasing the set value of the feed water temperature from T₁′ to T₂′ is set. Concretely, similarly to the method shown in the second embodiment, the core flow rate is set so that the core inlet cooling water temperature becomes a temperature which is equal to or lower than the upper limit temperature causing no cavitation and is close to the upper limit temperature in the state that the core flow rate is increased, in consideration of the quantity of the core flow rate to be increased to keep the reactor power at the rated power. The T₂′ obtained as mentioned above is a set value of the feed water temperature to be set in the respective small sections c1, c2 and c3 when the core flow rate is reduced to set value W₁′ of the core flow rate in the respective small sections b1, b2, and b3, and is stored in the memory 38.

From the aforementioned, the number of candidates of the set value of the feed water temperature to be set in the small sections c1, c2 and c3 is two such as T₃ and T₂′. If the core flow rate reaches actually the set value W₂ of the core flow rate in the respective small sections b1, b2 and b3, the set value of the feed water temperature is reduced from T₂ to T₃ and the operation in the small sections c1, c2 and c3 is started. If, inversely, the core flow rate is reduced actually to the set value W₁′ of the core flow rate in the small sections b1, b2 and b3, the set value of the feed water temperature is increased from T₁′(=T₂) to T₂′ and the operation in each of the small sections c1, c2 and c3 is started. If the core flow rate does not reach both set values W₂ and W₁′ of the core flow rate in the respective small sections b1, b2 and b3, the operation in each of the small sections b1, b2 and b3 is continued with set value T₂(=T₁′) of the feed water temperature kept as it is. This embodiment shown in FIG. 5 describes an example that the core flow rate reaches the set value W₂ of the core flow rate, and the feed water temperature is lowered from T₂ to T₃, and the operation in each of the small sections c1, c2, and c3 is started.

The set values of the core flow rate in the small sections c1, c2 and c3 are the maximum core flow rate. When the core flow rate reaches the maximum core flow rate, similarly to the first embodiment, the control rod pattern change is executed after the small sections c1 and c2, and the operation during the second period that the set value of the feed water temperature is T_{E}, that is, in the small section d3 is started after the small section c3.

In this embodiment, unlike the first embodiment for presetting the set value of the feed water temperature of each small section, the set values of the feed water temperature are stored in the memory 38 as a list, and during operation, the set value of the feed water temperature of each small section is selected and set from the list in accordance with the actual excess reactivity change and core flow rate change. Thus, according to this embodiment, even if the excess reactivity change is different from the estimation before operation under the influence of stop beyond the plan of the nuclear power generation plant, an effect of availability of flexible correspondence can be obtained.

Further, in this embodiment, T₁=T₂′ and T₂=T₁′ are set, though there is not need to set them always and any is acceptable as long as T₁>T₂ and T₁′<T₂′.

This embodiment can obtain the effects produced in the first embodiment.

What is claimed is:

1. An method for operating a nuclear power generation plant, comprising the steps of:
forming a plurality of control rod patterns by operating a plurality of control rods during a first period of one operation cycle of a reactor including said first period before a point of time when all control rods are completely withdrawn from a core of said reactor and a core flow rate reaches firstly a set core flow rate, and a second period after said point of time,
controlling stepwise at least once a temperature of feed water supplied to said reactor based on a different set feed water temperature during a period included in said first period for operating said reactor with a formed same control rod pattern, and
continuing feed water temperature control based on said set feed water temperature until said core flow rate reaches a set core flow rate set based on said set feed water temperature.

2. The method for operating a nuclear power generation plant according to claim 1, wherein said feed water temperature during said second period is controlled based on another set feed water temperature lower than said respective set feed water temperature used during said first period.

3. The method for operating a nuclear power generation plant according to claim 1, wherein said stepwise feed water temperature control is executed by controlling said feed water temperature based on first said set feed water temperature in a first small section during said period where said reactor is operated with said same control rod pattern, and by controlling said feed water temperature based on second said set feed water temperature lower than said first set feed water temperature in a second small section following said first small section during said period where said reactor is operated with said same control rod pattern.

4. The method for operating a nuclear power generation plant according to claim 3, wherein said core flow rate is increased in said first and second small sections.

5. The method for operating a nuclear power generation plant according to claim 3, wherein when said first set feed water temperature is changed to said second set feed water temperature, said feed water temperature is lowered and said core flow rate is reduced.

6. The method for operating a nuclear power generation plant according to claim 1, wherein said stepwise feed water temperature control is executed by controlling said feed water temperature based on first said set feed water temperature in a first small section during said period where said reactor is operated with said same control rod pattern, and by controlling said feed water temperature based on second said set feed water temperature higher than said first set feed water temperature in a second small section following said first small section during said period where said reactor is operated with said same control rod pattern.

7. The method for operating a nuclear power generation plant according to claim 6, wherein said core flow rate is reduced in said first and second small sections.

8. The method for operating a nuclear power generation plant according to claim 6, wherein when said first set feed water temperature is changed to said second set feed water temperature, said feed water temperature is raised and said core flow rate is increased.

9. The method for operating a nuclear power generation plant according to claim 1, wherein said set core flow rate is calculated by using a heat balance calculation apparatus.

10. The method for operating a nuclear power generation plant according to claim 1, wherein control for said core flow rate until said core flow rate reaches said set core flow rate is executed so that a core inlet coolant temperature corresponding to said feed water temperature becomes a temperature equal to or lower than an upper limit temperature causing no cavitation by a pump for feeding a coolant to said core and close to said upper limit temperature.

11. An method for operating a nuclear power generation plant, comprising the steps of:
controlling stepwise at least once a temperature of water supplied to a reactor based on different set feed water temperature during each operation period, in which different control rod patterns formed in a reactor is used separately, of a operation cycle of said reactor, and
executing continuously said feed water temperature control using said set feed water temperature until a core flow rate reaches a set core flow rate set based on said set feed water temperature.

12. A nuclear power generation plant comprising:
a reactor,
a steam system including a turbine and for introducing steam generated in said reactor,
a feed water system including feed water heating apparatus and for supplying feed water heated by said feed water heating apparatus to said reactor, and
a feed water temperature control apparatus for controlling stepwise at least once a temperature of water supplied to a reactor based on different set feed water temperature during each operation period, in which different control rod patterns formed in a reactor is used separately, of a operation cycle of said reactor, and executing continuously said feed water temperature control using said set feed water temperature until a inputted core flow rate reaches a set core flow rate set based on said set feed water temperature.

13. The nuclear power generation plant according to claim 12, wherein said feed water temperature control apparatus controls said feed water temperature based on another set feed water temperature lower than said respective set feed water temperature used for said stepwise control during said operation period that said reactor is operated with said control rod pattern that all control rods are completely withdrawn from a core of said reactor among said control rod patterns and after a point of time when said inputted core flow rate reaches firstly a set core flow rate.

14. The nuclear power generation plant according to claim 12 further comprising:
a heat balance calculation apparatus for obtaining said set core flow rate based on said set feed water temperature.
